(19) United States
(12) Patent Application Publication
(10) Pub. No.: US 2015/0234996 A1
(43) Pub. Date: Aug. 20, 2015

(54) METHOD AND A DEVICE FOR USE IN A PATIENT MONITORING SYSTEM TO ASSIST A PATIENT IN COMPLETING A TASK

(71) Applicant: KONINKLIJKE PHILIPS N.V., EINDHOVEN (NL)

(72) Inventors: Frank Wartena, Eindhoven (NL); Muhammad Asim, Eindhoven (NL); Charles Leonardus Cornelius Maria Knibbeler, Eindhoven (NL)

(21) Appl. No.: 14/422,950

(22) PCT Filed: Aug. 30, 2013
(86) PCT No.: PCT/IB2013/058149

§ 371 Date: Feb. 20, 2015

Related U.S. Application Data
(60) Provisional application No. 61/695,048, filed on Aug. 30, 2012.

(51) Int. Cl. G06F 19/00

(52) U.S. Cl. CPC G06F 19/3418; G06F 19/3456

(57) ABSTRACT

There is provided a method of operating a patient device in a patient monitoring system to assist a patient in completing a task, there being a redefined set of types of task for the patient to complete, the method comprising receiving information on a task for the patient to complete, the information comprising an indication of the type of task from the predefined set the patient is to complete; determining one or more operations associated with the type of task indicated in the received information that the patient device is to perform on initiation of the task or on occurrence of a predefined event; and on initiation of the task by the patient or on occurrence of the predefined event, performing the one or more operations associated with the task.

### TECHNICAL BACKGROUND TO THE INVENTION

The invention relates to a patient monitoring system in which a patient is provided with a device to assist them with monitoring and managing a health condition, and in particular relates to the way in which the patient monitoring system manages tasks that are set for the patient to complete.

### BACKGROUND TO THE INVENTION

Various patient monitoring (personal telehealth) systems have been proposed. Conventionally such telehealth systems involve a patient being provided with one or more measurement devices and/or another patient device, such as a computer, smart phone or tablet computer, so the patient can take measurements of their physiological characteristics, complete surveys or questionnaires on their current status or compliance with a healthcare regimen, view educational or instructional content related to the patient's health condition, and/or remind the patient when they are to take the next dose of medication.

Current telehealth systems assign and present tasks to patients in order to assist the patient in complying with a prescribed mediation and/or exercise regimen. Such tasks might include “measure your weight” or “complete the survey on diet”. Through the presentation of these tasks, patients are made aware of what actions they need to take to manage their health condition.

### SUMMARY OF THE INVENTION

The mechanism of these tasks is similar to how office productivity tools such as Microsoft Outlook™ manage tasks. These tools enable users or the system to create and use tasks to structure their working activities. Common parameters of tasks include an owner (i.e. who the task is for), the start date, the due date (i.e. when the task must be completed by), priority (i.e. how important the task is), status (i.e. not yet completed, completed, etc.), title, summary and description. These tools often semantically understand the parameters such as owner (which can be defined in terms of a system username or email address, etc.), start/due date, priority and status since they may have a predetermined format and/or a predetermined list of options (e.g. low priority, medium priority, high priority, etc.). Due to this semantic understanding, the tools can take actions in respect of these parameters (for example issuing a reminder to the owner as the due date approaches). However, the title and description fields, which typically indicate the details of the task the patient is to perform, and in some cases how the task is to be performed, are ‘free text’ fields, meaning that there are little or no restrictions on their format or content, and the tools are not able to understand or use the information in these fields.

Thus, these tools are able to help a patient with the timing of a task, but is not able to support the patient with the completion of the task itself. The tools are also not able to verify that the patient-selected status of a task (e.g. completed) is correct, or vice versa. Therefore, there is a need for an improved way of managing tasks within a patient monitoring or telehealth system.

According to a first aspect of the invention, there is provided a method of operating a patient device in a patient monitoring system to assist a patient in completing a task, there being a predefined set of types of task for the patient to complete, the method comprising receiving information on a task for the patient to complete, the information comprising an indication of the type of task from the predefined set the patient is to complete; determining one or more operations associated with the type of task indicated in the received information that the patient device is to perform on initiation of the task or on occurrence of a predefined event; and on initiation of the task by the patient or on occurrence of the predefined event, performing the one or more operations associated with the task.

In some embodiments, the step of receiving information on the task for the patient to complete comprises receiving the information from a server in the patient monitoring system.

In other embodiments, the step of receiving information on the task for the patient to complete comprises retrieving the information from a memory in the patient device.

In some embodiments, the patient device has information on the operation or operations associated with each type of task in the predefined set stored in a memory, and wherein the step of determining the one or more operations comprises looking up the operation or operations associated with the type of task indicated in the received information.

In other embodiments, the information received on the task includes information indicating the one or more operations the patient device is to perform, and wherein the step of determining the one or more operations comprises reading the indication of the one or more operations contained in the received information.

In particular embodiments, the operation or operations the patient device is to perform comprises any one or more of starting a workflow to guide the patient through the task that the patient is to complete, moving a workflow on to a subsequent step or closing the workflow on detection of the completion of a predetermined action by the patient, placing an input cursor on a display of the patient device in an appropriate field, issuing instructions to the patient regarding the performance or completion of the task, issuing one or more reminders to the patient regarding the task and retrieving a survey, questionnaire, educational material or other content from a memory of the patient device or other storage location.

In some embodiments, the received information on the task further comprises information indicating a specific action or task sub-type related to the indicated type of task.

In preferred embodiments, the predefined set of types of task for the patient to complete comprises one or more of taking a measurement of a physiological characteristic, completing a survey or questionnaire, reviewing educational content and taking a dose of medication.

In particular embodiments, when the indicated type of task indicates the patient is to take a measurement of a physiological characteristic, the received information on the task further comprises additional information indicating a specific action or task sub-type related to the measurement of a physiological characteristic, the additional information indicating the particular physiological characteristic of the patient that is to be measured.

In particular embodiments, when the indicated type of task indicates the patient is to complete a survey or questionnaire, the received information on the task further comprises additional information indicating a specific action or task sub-type related to the survey or questionnaire, the additional information indicating the type of survey or questionnaire to be completed and/or a location or address at which the survey or questionnaire is stored.

In particular embodiments, when the indicated type of task indicates the patient is to review educational content, the received information on the task further comprises additional information indicating a specific action or task sub-type related to the educational content, the additional information indicating the type of content to be reviewed and/or a location or address at which the content is stored.

In particular embodiments, when the indicated type of task indicates the patient is to take a dose of medication, the received information on the task further comprises additional information indicating a specific action or task sub-type related to the dose of medication, the additional information indicating the type of medication to be taken and/or the amount of medication in the dose.

The indication of the type of task the patient is to complete can comprise a numerical, text-based or coded value in a ‘task type’ field in a data structure used to define a task, with each type of task in the predefined set having a respective value associated therewith.

According to a second aspect of the invention, there is provided a computer program product having computer-readable code embodied therein, the computer-readable code being configured such that, on execution by a suitable computer or other electronic device, the computer or electronic device performs a method as described above.

According to a third aspect of the invention, there is provided a control unit for a patient device in a patient monitoring system, wherein the control unit is configured to receive information on a task for the patient to complete, the information comprising an indication of the type of task the patient is to complete, there being a predefined set of types of task; determine one or more operations associated with the type of task indicated in the received information that the patient device is to perform on initiation of the task or on occurrence of a predefined event; and perform the one or more operations associated with the task on initiation of the task by the patient or on determining that the predefined event has occurred.

In some embodiments, the control unit is configured to receive the information on the task for the patient to complete from a server in the patient monitoring system.

In other embodiments, the patient device has information on the task for the patient to complete stored in a memory, and the control unit is configured to retrieve the information on the task for the patient to complete from the memory.

In some embodiments, the patient device has information on the operation or operations associated with each type of task in the predefined set stored in a memory, and the control unit is configured to determine the one or more operations by looking up the operation or operations associated with the type of task indicated in the received information.

In other embodiments, the information received on the task includes information indicating the one or more operations the patient device is to perform, and the control unit is configured to determine the one or more operations by reading the indication of the one or more operations contained in the received information.

In particular embodiments, the operation or operations the patient device is to perform comprises any one or more of starting a workflow to guide the patient through the task that the patient is to complete, moving a workflow on to a subsequent step or closing the workflow on detection of the completion of a predetermined action by the patient, placing an input cursor on a display of the patient device in an appropriate field, issuing instructions to the patient regarding the performance or completion of the task, issuing one or more reminders to the patient regarding the task and retrieving a survey, questionnaire, educational material or other content from a memory of the patient device or other storage location.

In some embodiments, the received information on the task further comprises information indicating a specific action or task sub-type related to the indicated type of task.

In preferred embodiments, the predefined set of types of task for the patient to complete comprises one or more of taking a measurement of a physiological characteristic, completing a survey or questionnaire, reviewing educational content and taking a dose of medication.

In particular embodiments, when the indicated type of task indicates the patient is to take a measurement of a physiological characteristic, the received information on the task further comprises additional information indicating a specific action or task sub-type related to the measurement of a physiological characteristic, the additional information indicating the particular physiological characteristic of the patient that is to be measured.

In particular embodiments, when the indicated type of task indicates the patient is to complete a survey or questionnaire, the received information on the task further comprises additional information indicating a specific action or task sub-type related to the survey or questionnaire, the additional information indicating the type of survey or questionnaire to be completed and/or a location or address at which the survey or questionnaire is stored.

In particular embodiments, when the indicated type of task indicates the patient is to review educational content, the received information on the task further comprises additional information indicating a specific action or task sub-type related to the educational content, the additional information indicating the type of content to be reviewed and/or a location or address at which the content is stored.

In particular embodiments, when the indicated type of task indicates the patient is to take a dose of medication, the received information on the task further comprises additional information indicating a specific action or task sub-type related to the dose of medication, the additional information indicating the type of medication to be taken and/or the amount of medication in the dose.

The indication of the type of task the patient is to complete can comprise a numerical, text-based or coded value in a ‘task type’ field in a data structure used to define a task, with each type of task in the predefined set having a respective value associated therewith.

According to a fourth aspect of the invention, there is provided a patient monitoring system, comprising a patient device comprising a control unit as described above; and a server that is configured to generate information on a task for the patient to complete, the information indicating a type of task from the predefined set of task types, and to communicate the information on the task to the patient device.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of a patient monitoring or telehealth system in which the invention can be implemented;

FIG. 2 is a flow chart illustrating a method of operating a patient device according to an embodiment of the invention;

FIG. 3 is an illustration of an exemplary data structure for a task according to an embodiment of the invention;

FIG. 4 is an illustration of exemplary task types in an embodiment of the invention;

FIGS. 5, 6 and 7 are illustrations of exemplary additional information that can be specified for some of the exemplary task types shown in FIG. 4;

FIG. 8 is a flow chart illustrating a method of operating a patient device according to a specific implementation of the invention; and

FIG. 9 is a flow chart illustrating a method of operating a patient device according to another specific implementation of the invention.

### DETAILED DESCRIPTION OF THE PREFERRED EMBODIMENTS

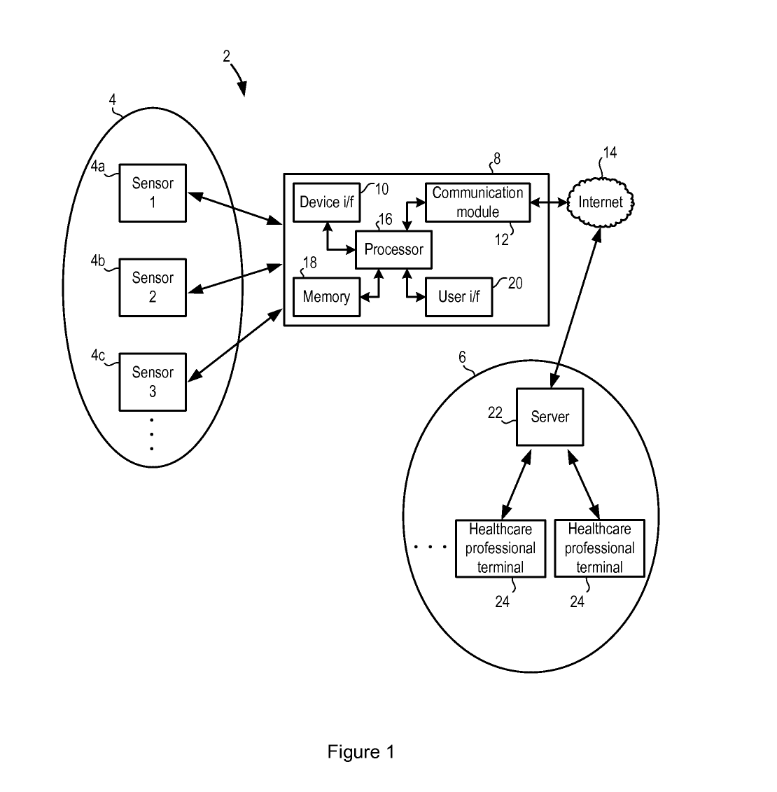

FIG. 1 illustrates an exemplary patient monitoring system 2 in which the invention can be implemented. One or more measurement devices or sensors 4 are provided and are used for monitoring or measuring physiological characteristics of the patient. As an example, measurement device 4a may be a blood pressure monitor, measurement device 4b may be a glucometer and measurement device 4c may be a weighing scale, although it will be appreciated that other measurement devices may additionally or alternatively be used. The health data acquired by these measurement devices may then be transmitted to a remote healthcare service 6 for recording and/or analysis.

Whilst some measurement devices 4 may be able to communicate directly with a healthcare service 6, typically a local apparatus 8, referred to herein as a telehealth hub, patient device or patient interface device, is used to collect and collate the data locally and then transmit the data to the healthcare service 6. Thus each of the measurement devices 4a-c are adapted to communicate with the telehealth hub 8. The measurement devices 4a-c may be arranged to communicate with the telehealth hub 8 wirelessly via any suitable wireless protocol and/or via any suitable wired connection, i.e. the relevant measurement device 4 could be plugged into the telehealth hub 8 in order to transfer data. The measurement devices 4a-c may be arranged to transfer data automatically when new data is acquired, provided that a connection with the telehealth hub 8 is established, and/or to record measurement data in a local memory and then transmit it to the telehealth hub 8 periodically or at user initiated times, for instance when a connection with the telehealth hub 8 has been established.

The telehealth hub 8 and measurement devices 4a-c may all be located in an environment, such as a home environment of the patient, which is remote from a healthcare provider 6. The measurement devices 4a-c may be used within the home environment although at least some measurement devices may be portable and usable in other locations. Such data may be stored in the measurement device 4 and then uploaded to the telehealth hub 8 when the patient returns home.

The telehealth hub 8 is configured to receive the data from the measurement devices 4a-c through device interface(s) 10 and to transmit data using communication module 12 to the healthcare services 6, for instance via the Internet 14 or other wide area network (WAN). The communication module 12 of the telehealth hub 8 may therefore provide a wired Internet or network connection although in other embodiments the communication module 12 in the telehealth hub 8 may be arranged to transfer data via a suitable mobile telephone network or any other type of communication network. In some embodiments, the telehealth hub 8 may be a dedicated telehealth hub apparatus but in other embodiments another device which is already suitable for remote communication may be configured to act as a telehealth hub, for instance a desktop or laptop computer, a mobile telephone, a tablet computer, a set-top entertainment box or the like. It will be appreciated that if the telehealth hub 8 is implemented in a portable device with a communications facility, such as a mobile telephone or portable computer, then the telehealth hub 8 may itself be used in other environments than the home environment.

In addition to the device interface(s) 10 and communication module 12, the telehealth hub 8 comprises a processor or control unit 16 that controls the operation of the telehealth hub 8, a memory module 18 (such as a hard disc, an optical storage medium or a non-volatile memory chip) that stores information and program code for use by the processor 16 in implementing the invention, and a user interface 20 which allows the patient to interact with the telehealth hub 8. The user interface 20 can comprise a display or screen (which may be a touch screen), one or more buttons or keys, a pointer-control device, such as a mouse or touchpad, and/or one or more audio speakers.

The healthcare service 6 comprises a server 22 that is connected to the Internet or WAN 14 and that receives and stores patient data sent from the telehealth hub 8. The server 22 is connected to one or more computer terminals or devices 24 that are used by healthcare professionals to access the patient data.

It will be appreciated that although the measurement devices 4 and the telehealth hub 8 are shown as separate devices in FIG. 1, one or more of the measurement devices 4 can be integrated into the telehealth hub 8.

In the illustrated patient monitoring system 2, the server 22 is the device that is responsible for implementing and executing the care plan of the patient. This care plan can include many tasks that the patient needs to complete in order to manage their health condition. These tasks can include measuring vital signs, other physiological characteristics, completing surveys, reviewing educational material, taking medication, etc. To implement the care plan, the server 22 sends information on the tasks the patient is to complete to the telehealth hub 8 via the Internet or WAN 14.

The telehealth hub 8 (which can also be known as an application hosting device (AHD)) is the device with which the patient mainly interacts and this is the device that in most cases is responsible for conveying the task information received from the server 22 to the patient.

As described above, current tools that have a task or reminder function for a user are able to help a patient with the timing of a task, but are not able to actively support the patient with the completion of the task itself. The tools are also not able to verify that the patient-selected status of a task (e.g. completed) is correct, or vice versa. Therefore, there is a need for an improved way of managing tasks within a patient monitoring or telehealth system 2.

In accordance with the invention, the telehealth system 2 (or a part or parts of the telehealth system 2 such as the telehealth hub 8 and/or server 22) is provided with semantic understanding of tasks, for example including the actual action or actions that is or are required to be performed by the patient in order for the task to be completed. This semantic understanding is provided by specifying one or more additional parameters in the definition of a task in addition to the standard semantically-understood parameters which can include the owner (i.e. which patient the task is for), the start date, the due date (i.e. when the task must be completed by), priority (i.e. how important the task is), status (i.e. not yet completed, completed, etc.), and the non-semantically understood parameters which can include the title, summary and/or description of the task.

In preferred embodiments, the one or more additional parameters can be used to indicate the type of task to be completed by the patient. Examples of the types of tasks to be completed by the patient include taking a measurement of a physiological characteristic, completing a survey, reviewing educational content, taking the next dose of medication, etc. A set of task types can be predefined in the telehealth system 2, and a task type selected for each task that is to be completed by the patient. The task type can be selected at the time that the task or action is created by the patient, by the healthcare professional or by the server 22.

In further preferred embodiments, the one or more additional parameters also comprise a parameter that defines the sub-type of task to be completed by the patient. The available task sub-types can depend on the type of task selected (i.e. there can be a respective set of task sub-types applicable to one or more of the task types). As with the task types, a set of task sub-types can be predefined in the telehealth system 2, and a task sub-type selected once a task type has been selected for a particular task. The task sub-type can be selected at the time that the task is created by the patient, healthcare professional or the server 22. For example, for the ‘take a measurement’ task type, the task sub-type parameter can include the options: weight, blood pressure, pulse, glucose, etc.; for the ‘complete a survey’ task type, the task sub-type parameter can include the options: diet, general health, mental health, etc., or alternatively an address (such as a URL) or a storage location (for example a directory in the memory module 18 in the telehealth hub 8) where the survey is located; for the ‘review educational content’ task type, the task sub-type can include the options: exercise content, message from a healthcare professional, etc., or alternatively an address or location where the content is located; for the ‘take a medication dose’ task type, the task sub-type can include options for the type/name of the medication to be taken and/or the amount of medication to be taken.

In alternative embodiments, it will be appreciated that rather than specifying a general task type and then specifying a task sub-type, a single larger set of task types can be defined that includes all of the information for the task required by the telehealth hub 8 to semantically understand the task. For example, the task types can include take a weight measurement, take a blood pressure measurement, complete a diet survey, complete a general health questionnaire (with, for example, a specified address or location for that questionnaire), review an exercise training video, take a 500 mg tablet of medication X, etc.

To provide the semantic understanding, a set of one or more operations is defined for the telehealth hub 8 to perform in connection with each type of task (and/or sub-type, where specified). The specified operation(s) will depend on the type (and sub-type) of task selected, and can be performed by the telehealth hub 8 as appropriate when the task is started or opened, or on occurrence of a predefined event (such as a measurement being received from a specific sensor 4 or a patient indicating they are ready to start or complete the task). Information on the operation or operations to be performed by the telehealth hub 8 in connection with each type of task (and/or sub-type) may be provided by the server 22 to the telehealth hub 8 along with the other information on the task (e.g. the due date, task name, type of task, etc.) or alternatively the telehealth hub 8 can store information on operations associated with each task (and/or sub-type) and determine the appropriate actions using the information on the task received from the server 22.

For example the telehealth system 2 can be assigned an operation to automatically start a workflow that helps guide the patient through the task that was assigned to them, e.g. when the patient opens or starts a task such as “measure your weight” on the patient device 8, the assigned operation can cause the device 8 to automatically navigate the input cursor on the display of the user interface 20 to the weight measurement entry field, or cause the device 8 to issue an instruction to the user to step on a weight sensor 4, or when the user opens or starts the task “complete the survey on diet” the operation for the telehealth hub 8 could cause the hub 8 to automatically open the diet survey from the specified URL or memory location so the hub 8 is ready for the user to answer the questions.

In addition or alternatively, the specified operation(s) can cause the telehealth hub 8 to automatically check if a task has been completed, for example when the user has a task “measure your weight” the telehealth hub 8 can automatically mark that task as ‘completed’ if the telehealth hub 8 receives a new weight measurement from the weight sensor 4 (the receipt of the weight measurement from the weight sensor 4 being a predefined event as described above). Likewise, where the patient's medication is dispensed by an electronic device that is connected to the telehealth system 2, the telehealth hub 8 can mark a ‘take medication’ task as completed when it receives a signal from the medication dispensing device indicating that a dose of medication has been removed by the patient.

In addition or alternatively to the above, the specified operation(s) can include sending or issuing reminders to the patient to complete the task. In this case, the reminders can be generated based on the task type (and sub-type specified), e.g. “please do not forget to take medication X before noon”.

The patient will benefit from this improved task management since it results in a smoother workflow for the patient as the hub-side of the task can be automatically started (e.g. survey retrieved and opened, educational content loaded), the taking of measurements detected automatically from the sensors 4 in the system 2, and there being less unnecessary reminders to the patient (since a task can be marked completed automatically when the patient has completed their required action without the patient having to manually mark the task as completed).

The standardized format for task information is defined in RFC2445 (http://www.ietf.org/rfc/rfc2445.txt) section 4.6.2 as the to-do item: “Description: A “VTODO” calendar component is a grouping of component properties and possibly “VALARM” calendar components that represent an action-item or assignment. For example, it can be used to represent an item of work assigned to an individual; such as “turn in travel expense today”.

This standard uses free text fields for parameters such as title, summary, description as described above. In some implementations of the invention, the one or more additional parameters or fields such as task type and sub-type can be added to the VTODO task definition, but it will be appreciated that similar approaches could be used for other task definition formats. The task type and sub-type parameters or fields are assigned a text-based, numerical or coded value from a predefined range of values (e.g. 0-9) each of which is associated with a respective type of task or task sub-type. The semantic understanding of the task by the telehealth hub 8 (and/or server 22, as appropriate) will be provided by associating one or more operations for the telehealth hub 8 to each of the values in the predefined range of values for the task type and sub-type fields.

In some embodiments, one of the values in the predefined range for the task type (or alternatively any value input in the field that does not take one of the values in the predefined range—in other words the task type field is used as a ‘free text’ field where only a small subset of all possible input values have a defined meaning) can be used to indicate an ‘unspecified’ task to the telehealth hub 8. This ‘unspecified’ task can be used for any task for the patient that is not one of the tasks predefined in the system 2. In this case, the free text entries in the “task type”, “task name” and/or “task description” fields can be used to indicate the type of task to be performed by the patient. It will be appreciated that the telehealth hub 8 will not have semantic understanding of this unspecified task and therefore will not be able to determine task-specific operations to perform to assist the patient in completing the task.

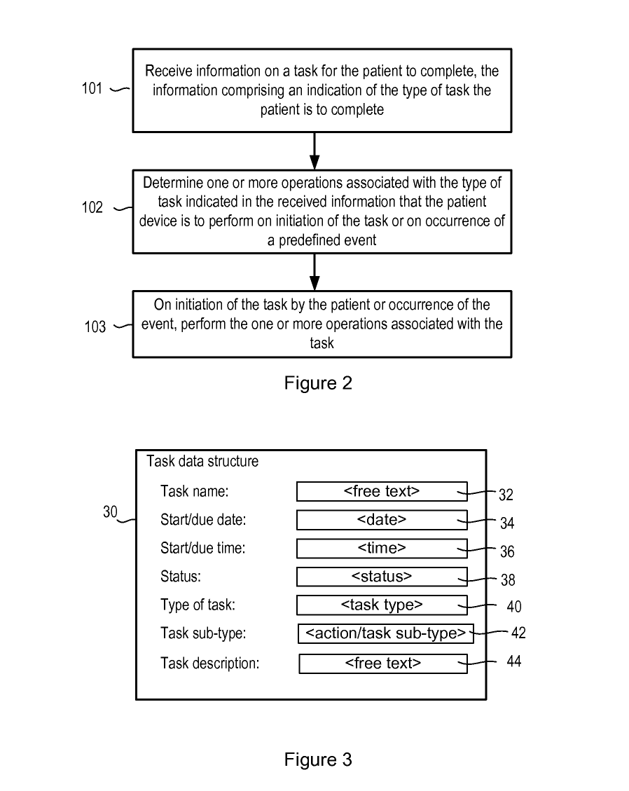

The flow chart in FIG. 2 illustrates a method of operating a patient device 8 according to an embodiment of the invention. In step 101, the patient device 8 receives information on one or more tasks for the patient to complete. The information comprises at least an indication of the type of task the patient is to complete, with the indicated task type being one found in a predefined set of task types. As noted above, the indication of the type of task the patient is to complete can comprise a numerical, text-based or coded value in a ‘task type’ field in a data structure used to define a task, with each type of task in the predefined set being associated with a respective numerical, text-based or coded value.

Step 101 can comprise receiving the task information from another device in the telehealth network 2, such as server 22 or healthcare professional terminal 24, or alternatively retrieving the task information from the memory module 18. The task information can be provided in the modified VTODO format discussed above, or in an alternative format.

Then, in step 102, the telehealth hub 8 determines one or more operations it is to perform to assist the patient in completing the task. Indications of the operations associated with the type of task can be received from the server 22 or healthcare professional terminal 24 with the task information itself, or alternatively the telehealth hub 8 can be programmed with the operations to be taken for each of the possible task types (and sub-types), in which case the telehealth hub 8 looks up the appropriate operations using the task type specified in the received task information.

The patient device 8 can also receive indications of when these one or more operations are to be performed (e.g. on initiation of the task, and/or on occurrence of a predefined event during the task), or again these indications could be programmed into the telehealth hub 8.

Then, in step 103, on initiation of the task by the patient, or on occurrence of the predefined event, the patient device 8 performs the one or more operations associated with the task.

FIG. 3 shows an exemplary data structure 30 for a task according to the invention. Information on the task can be communicated between the server 22 and telehealth hub 8 using this task structure 30. Data entry fields corresponding to this data structure 30 could be presented to a healthcare professional when the patient's healthcare regimen is being prepared and/or to a patient when setting their own tasks as part of the treatment or management regimen. It will also be appreciated that tasks can be set automatically by the telehealth system 2, in which case the server 22 or telehealth hub 8 can automatically populate the required fields.

Thus, in the data structure 30 shown in FIG. 3, there is a field 32 for a task name to be entered (e.g. measure weight, take medication, etc.). As in conventional task definitions, this field is free-text, meaning that the user (e.g. healthcare professional or patient) is free to input any text and/or other characters into this field (subject to a maximum permitted number of characters).

As with conventional tasks, the data structure 30 also comprises a start/due date field 34 that allows the user to select the date on which the task is to be started and/or completed by, a start/due time field 36 to allow the user to input the time by which the task is to be started and/or completed by, a status field 38 that indicates the status of the task (e.g. initially ‘not yet started’, although subsequently it could be ‘in progress’ or ‘completed’).

As indicated above, the start/due date 34, start/due time 36 and status 38 fields are fields that are semantically understood by the patient device 8 as they have a predefined set of available options (i.e. they are not free-text fields).

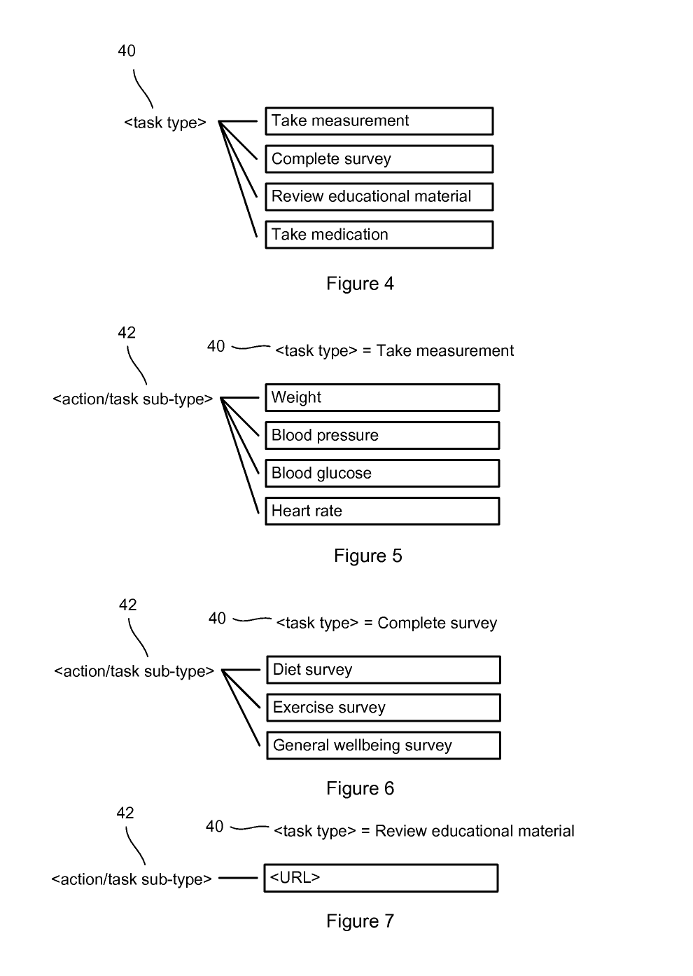

In accordance with an aspect of the invention, a further field 40 is provided which is used to indicate the type of task to be performed by the patient. As described above, there is a predefined (i.e. closed) set of task types which is known to the telehealth hub 8. FIG. 4 illustrates four exemplary values for the task type field 40 in accordance with the invention. The four task types comprise “Take measurement”, “Complete survey”, “Review educational material” and “Take medication”. It will be appreciated that each task type shown in FIG. 4 may be represented by a number or code that is input into the task type field 40, rather than inputting text such as “Take measurement”.

In some embodiments (for example in FIG. 4 where the task type field 40 only specifies the general nature of the task), the data structure 30 can comprise a further field 42 for allowing the task sub-type or action (e.g. weight, blood pressure, survey type or location, etc.) to be specified. As described in more detail below, the available parameter values for the task sub-type field 42 can depend on the task type entered into field 40.

FIG. 5 shows the possible task sub-type values when the task type specified in field 40 is “Take measurement”. Thus, the possible sub-types available for entry in field 42 are “weight”, “blood pressure”, blood glucose”, “heart rate”, etc.

FIG. 6 shows the possible task sub-type values when the task type specified in field 40 is “Complete survey”. Thus the possible sub-types available for entry in field 42 are “Diet survey”, “Exercise survey”, “General wellbeing survey”, etc. Alternatively (and similarly to that shown in FIG. 7 below), rather than presenting a preset list of available sub-types, field 42 can be a field that allows an address (e.g. URL) or location (e.g. in the memory module 18) to be specified where the survey is stored. Of course, it will be appreciated that, although not shown in FIG. 6, each of the task sub-types shown may separately have an associated address or location where each survey is located (which can be determined in step 102 above as part of determining the operation to be performed by the telehealth hub 8 in respect of the task type).

FIG. 7 shows the possible task sub-types when the task type specified in field 40 is “Review educational material”. In this case, the task sub-type field 42 allows the user to input an address or location where the educational material is stored. Alternatively, as with the “Complete survey” task type shown in FIG. 6, a drop-down list of types of educational material and/or locations can be presented to the user in field 42 when the task type “Review educational material” is selected in field 40.

As with the task type field 40 above, the value of the parameter to be entered into field 42 may be a numerical or coded value rather than the text indicated in FIG. 5 or 6.

Finally, returning to FIG. 3, as in conventional tasks, there is a field 44 for allowing a description of the task to be specified. As with the task name field 32, this field is free-text, which allows a description of the task or any other required information for the task to be entered. Alternatively, the content of this field 44 could be automatically filled according to the task type and/or task sub-types entered into field 40 and/or 42. For example, where a “Take measurement” task type is specified in field 40 and “weight” is specified in field 42, the task description field 44 could be automatically filled with a description of how to correctly operate the weight measurement device 4.

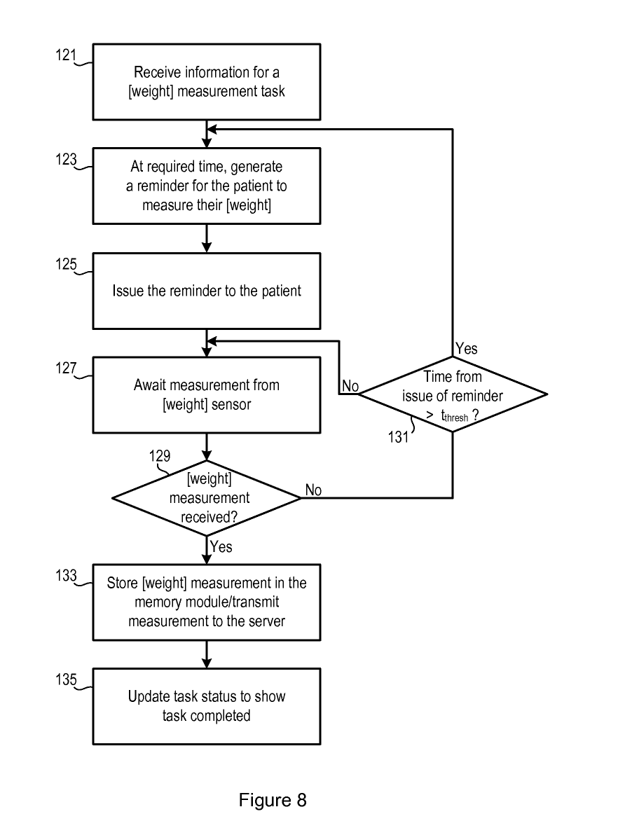

The flow chart in FIG. 8 illustrates a specific embodiment of a method of operating a telehealth hub/patient device 8 for a weight measurement task (i.e. where the task type is “Take measurement” in FIG. 4 and the task sub-type is “weight” in FIG. 5), although it will be appreciated that the method can be readily adapted to other types of measurement (as indicated in FIG. 8 by the parameter “weight” being shown in square brackets).

In a first step, step 121, the patient device 8 receives information for a weight measurement task. That is, the patient device 8 receives information indicating a task type “Take measurement” and a task sub-type “weight”, along with at least a date/time when the measurement is to be taken. The telehealth hub 8 determines the operations associated with this task type and task sub-type (for example by looking up the operations associated with the specified task type and sub-type in the memory module 18), and in particular identifies two specific operations for the patient device 8 to perform to improve the patient experience in completing the task. In particular, when the task is started, the patient device 8 is to automatically monitor a weight sensor 4 to determine when a measurement has been taken, and when the measurement is made and received by the patient device 8, the patient device 8 is to store the weight measurement and update the task status to indicate that the task has been completed.

Then, in step 123, the patient device 8 generates a reminder for the patient to remind them to measure their weight at the appropriate time. The appropriate time might be the date/time specified in the task information, or some predetermined time before the date/time specified for the completion of the task.

In step 125, the reminder is issued to the patient. Issuing the reminder may comprise displaying a message on the display in the user interface 20 of the patient device 8, flashing lights in the user interface 20, generating an audible sound (e.g. a spoken message or alarm tone), etc.

Then, in step 127, the patient device 8 awaits a weight measurement from the weight sensor 4. If it is determined in step 129 that no weight measurement has been received, the patient device 8 checks whether a predetermined time tₜₕᵣₑₛₕ has elapsed since the reminder was issued to the patient (step 131), and if not, the method returns to step 127 and awaits a measurement from the weight sensor 4. If the time elapsed since the reminder was issued to the patient exceeds tₜₕᵣₑₛₕ, the method returns to step 123 and a further reminder for the patient is generated.

When a weight measurement is received from the weight sensor 4, the method moves to step 133 in which the telehealth hub 8 completes the first operation associated with the specified task type and task sub-type by storing the weight measurement in the memory module 18 and/or transmitting the measurement to the server 22.

Then, the telehealth hub 8 completes the second operation associated with the specified task type and task sub-type and updates the task status to ‘completed’ to indicate that the patient has completed the task (step 135).

Thus, in this embodiment, the definition of a specific task type in the task information and knowledge at the telehealth hub 8 of operations associated with that task type allow the telehealth system 2 to automatically determine when the task has been completed and to automatically complete the task workflow for the patient, thereby reducing the interactions required by the patient with the patient device 8 compared to conventional telehealth systems 2.

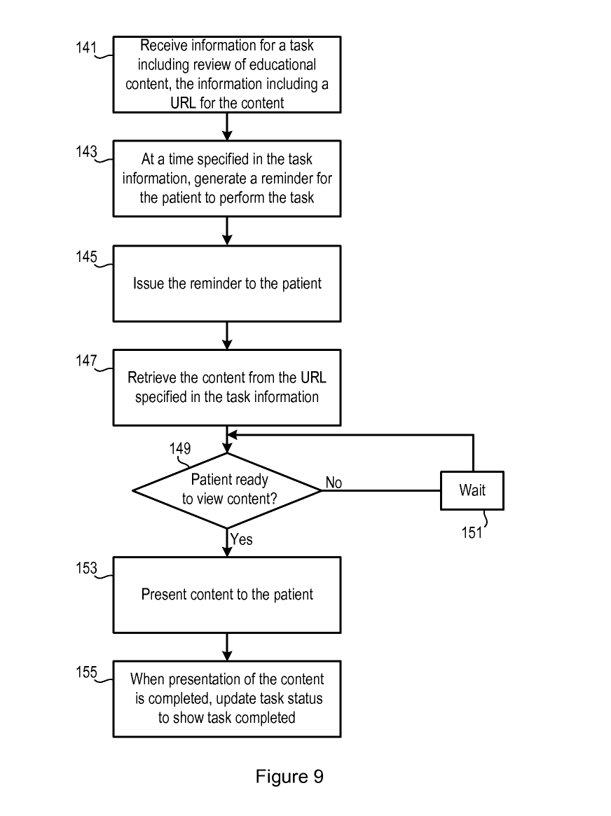

The flow chart in FIG. 9 illustrates a specific embodiment of a method of operating a telehealth hub/patient device 8 for a task involving the review of educational content (i.e. where the task type is “Review educational material” in FIG. 4 and a URL is provided in the task sub-type field 42 in FIG. 7), although it will be appreciated that the method can be readily adapted to other task types, such as completing a survey.

In a first step, step 141, the patient device 8 receives information for a review educational material task. That is, the patient device 8 receives information indicating a task type “Review educational material” and a task sub-type specifying a URL where the educational material is located on the Internet or WAN 14, along with at least a date/time by which the material is to be reviewed. The telehealth hub 8 determines the operations associated with this task type (for example by looking up the operations associated with the specified task type in the memory module 18), and in particular identifies two specific operations for the patient device 8 to perform to improve the patient experience in completing the task. In particular, when the task is started, the patient device 8 is to automatically retrieve the content from the specified URL address, and when the content is played by the patient device 8, the patient device 8 is to automatically update the task status to indicate that the task has been completed.

Thus, in step 143, the patient device 8 generates a reminder for the patient to remind them to review the educational material at the appropriate time. The appropriate time might be the date/time specified in the task information, or some predetermined time before the date/time specified for the completion of the task.

In step 145, the reminder is issued to the patient. Issuing the reminder may comprise displaying a message on the display in the user interface 20 of the patient device 8, flashing lights in the user interface 20, generating an audible sound (e.g. a spoken message or alarm tone), etc.

Then, in step 147, the telehealth hub 8 completes the first operation associated with the specified task type by retrieving the content from the specified URL address and waiting for the patient to indicate that they are ready for the content to be played. If it is determined in step 149 that no positive indication been received from the patient (e.g. the patient has indicated that they are not ready to review the content or no indication has been received, the patient device 8 waits (step 151) and returns to step 149. Alternatively, however, as with the method shown in FIG. 8, the patient device 8 can issue another reminder if a predetermined time period has elapsed.

When the patient indicates that they are ready to view the content, the content is played or presented to the patient (step 153). This step may comprise displaying the content on a display of the user interface 20 and/or playing an audio part of the content through a speaker or speakers in the user interface 20.

When the content has been played to the patient, the method moves to step 155 in which the telehealth hub 8 completes the second operation associated with the specified task type by updating the task status to ‘completed’ to indicate that the patient has completed the task.

Thus, in this embodiment, the definition of a specific task type in the task information and knowledge at the telehealth hub 8 of operations associated with that task type allow the telehealth hub 8 to automatically retrieve the required content to minimize a waiting time for the patient when they are ready to complete the task, and to determine when the task has been completed and update the task workflow for the patient, thereby reducing the interactions required by the patient with the patient device 8 compared to conventional telehealth systems 2.

There is therefore provided an improved way of managing tasks within a patient monitoring or telehealth system 2.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of operating a patient device in a patient monitoring system to assist a patient in completing a task, the patient device being coupled to a measurement device and/or a medication dispensing device, there being a predefined set of types of task for the patient to complete, the predefined set comprising at least one of a measurement task in which the patient is to take a measurement of a physiological characteristic using the measurement device and a medication task in which the patient is to take a dose of medication dispensed by the medication dispensing device, the method comprising:
receiving information on the task for the patient to complete, the information comprising an indication that the patient is to complete the measurement task or the medication task;
determining one or more operations associated with the type of task indicated in the received information that the patient device is to perform on initiation of the measurement task or medication task or on occurrence of a predefined event, wherein the one or more operations associated with a measurement task includes monitoring the measurement device for the taking of a measurement of the physiological characteristic and marking the measurement task as completed when the measurement is taken, and wherein the one or more operations associated with a medication task includes monitoring the medication dispensing device for the dispensing of a dose of medication and marking the medication task as completed when the dose of medication has been removed by the patient; and
on initiation of the measurement task or medication task by the patient or on occurrence of the predefined event, performing the one or more operations associated with the task.

2-3. (canceled)

4. A method as claimed in claim 1, wherein when the indicated type of task indicates the patient is to take a measurement of a physiological characteristic, the received information on the task further comprises additional information indicating a specific action or task sub-type related to the measurement of a physiological characteristic, the additional information indicating the particular physiological characteristic of the patient that is to be measured.

5. A method as claimed in claim 1, wherein when the indicated type of task indicates the patient is to take a dose of medication, the received information on the task further comprises additional information indicating a specific action or task sub-type related to the dose of medication, the additional information indicating the type of medication to be taken and/or the amount of medication in the dose.

6. A method as claimed in claim 1, wherein the step of receiving information on the task for the patient to complete comprises receiving the information from a server in the patient monitoring system.

7. A method as claimed in claim 1, wherein the step of receiving information on the task for the patient to complete comprises retrieving the information from a memory in the patient device.

8. A method as claimed in claim 1, wherein the patient device has information on the operation or operations associated with each type of task in the predefined set stored in a memory, and wherein the step of determining the one or more operations comprises looking up the operation or operations associated with the type of task indicated in the received information.

9. A method as claimed in claim 5, wherein the information received on the task includes information indicating the one or more operations the patient device is to perform, and wherein the step of determining the one or more operations comprises reading the indication of the one or more operations contained in the received information.

10. A method as claimed in claim 1, wherein the operation or operations the patient device is to perform comprises any one or more of starting a workflow to guide the patient through the task that the patient is to complete, moving a workflow on to a subsequent step or closing the workflow on detection of the completion of a predetermined action by the patient, placing an input cursor on a display of the patient device in an appropriate field, issuing instructions to the patient regarding the performance or completion of the task, issuing one or more reminders to the patient regarding the task and retrieving a survey, questionnaire, educational material or other content from a memory of the patient device or other storage location.

11. A method as claimed in claim 1, wherein the received information on the task further comprises information indicating a specific action or task subtype related to the indicated type of task.

12. A method as claimed in claim 1, wherein the predefined set of types of task for the patient to complete further comprises one or more of completing a survey or questionnaire and reviewing educational content.

13. A method as claimed in claim 12, wherein when the indicated type of task indicates the patient is to complete a survey or questionnaire, the received information on the task further comprises additional information indicating a specific action or task sub-type related to the survey or questionnaire, the additional information indicating the type of survey or questionnaire to be completed and/or a location or address at which the survey or questionnaire is stored.

14. A method as claimed in claim 12, wherein when the indicated type of task indicates the patient is to review educational content, the received information on the task further comprises additional information indicating a specific action or task sub-type related to the educational content, the additional information indicating the type of content to be reviewed and/or a location or address at which the content is stored.

15. A computer program product, comprising computer-readable code embodied therein, the computer-readable code being configured such that, on execution by a suitable computer or other electronic device, the computer or electronic device performs the method claimed in claim 1.

16. A control unit for a patient device in a patient monitoring system, the patient device being coupled to a measurement device and/or a medication dispensing device, wherein the control unit is configured to:
receive information on a task for the patient to complete, the information comprising an indication that the patient is to complete a measurement task or a medication task, wherein in the measurement task the patient is to take a measurement of a physiological characteristic using the measurement device and in the medication task the patient is to take a dose of medication dispensed by the medication dispensing device;
determine one or more operations associated with the type of task indicated in the received information that the patient device is to perform on initiation of the task or on occurrence of a predefined event, wherein the one or more operations associated with a measurement task includes monitoring the measurement device for the taking of a measurement of the physiological characteristic and marking the measurement task as completed when the measurement is taken, and wherein the one or more operations associated with a medication task includes monitoring the medication dispensing device for the dispensing of a dose of medication and marking the medication task as completed when the dose of medication has been removed by the patient; and
perform the one or more operations associated with the task on initiation of the measurement task or medication task by the patient or on determining that the predefined event has occurred.

17. A patient monitoring system, comprising:
a patient device comprising a control unit as claimed in claim 16;
a measurement device and/or a medication dispensing device coupled to the patient device; and
a server that is configured to:
generate information on which of the measurement task and medication task the patient is to complete; and
communicate the information on the task to the patient device.

18-19. (canceled)
